(19) United States
(12) Patent Application Publication
(10) Pub. No.: US 2026/0212456 A1
(43) Pub. Date: Jul. 23, 2026

(54) THERMOGRAPHIC IMAGE OPTIMIZATION METHOD AND DEVICE

(71) Applicant: CREATIVE SENSOR INC., Taipei City (TW)

(72) Inventors: Pei-Hsuan CHEN, Taipei City (TW); Yu-Huan SUNG, Taipei City (TW)

(73) Assignee: CREATIVE SENSOR INC., Taipei City (TW)

(21) Appl. No.: 19/034,024

(22) Filed: Jan. 22, 2025

(51) Int. Cl. G06T 5/60; G06T 5/50

(52) U.S. Cl. CPC G06T 5/60; G06T 5/50; G06T 2207/10048; G06T 2207/20081; G06T 2207/20084

(57) ABSTRACT

A thermographic image optimization method is disclosed, which includes: by a data capturing circuit, capturing a raw image from a thermographic device in a detection field; by a processor, updating a neural network model by utilizing multiple sample images and multiple sample mapping tables stored in a storage, where the multiple sample mapping tables indicate a correspondence relationship between pixel values in multiple sample images generated by the thermographic device in multiple training fields and the pixel values in the sample images being optimized; by the processor, inputting the raw image into the neural network model to generate an optimization mapping table; and by the processor, converting the raw image into an optimized image by utilizing the optimization mapping table.

### BACKGROUND OF THE DISCLOSURE

### Technical Field

The disclosure relates to a thermographic processing technique, particularly relates to a thermographic image optimization method and device.

### Description of Related Art

Due to diversity of target objects detected by thermographic devices, detection purposes, and varying individual subjective perceptions, traditional thermographic technologies have been unable to establish a standardized adjustment process for parameters such as contrast and brightness in images generated by the thermographic devices. Based on this, the traditional thermographic technologies often require a user to manually adjust the parameters for the images produced by the thermographic devices in a complex manner to obtain optimized thermographic images (i.e., reducing effect of environmental fields or surrounding objects on temperatures detected in various target objects). In addition, in different environmental fields, the traditional thermographic technologies also require the user to re-adjust the parameters to obtain the parameters suitable for a current field. Therefore, how to avoid a complex process for manual parameter adjustment and parameter re-adjustment being time-consuming for various environmental fields is a problem that those skilled in the art are eager to solve.

### SUMMARY OF THE INVENTION

The purpose of the disclosure is to provide a thermographic image optimization method and device, which solves the problem that previous techniques require a complex process for manual parameter adjustment and parameter re-adjustment being time-consuming for various environmental fields.

In order to achieve the above purpose, the disclosure provides a thermographic image optimization method, including:
step a) by a data capturing circuit, capturing a raw image from a thermographic device in a detection field;
step b) by a processor, updating a neural network model by utilizing multiple sample images and multiple sample mapping tables respectively corresponding to the multiple sample images stored in a storage, where the multiple sample mapping tables indicate a correspondence relationship between pixel values in the multiple sample images generated by the thermographic device in multiple training fields and pixel values in the multiple sample images being optimized;
step c) by the processor, inputting the raw image into the neural network model to generate an optimization mapping table; and
step d) by the processor, converting the raw image into an optimized image by utilizing the optimization mapping table.

In order to achieve the above purpose, the disclosure provides a thermographic image optimization device, including:
a data capturing circuit, configured for capturing a raw image from a thermographic device in a detection field;
a storage, configured for storing multiple sample images, multiple sample mapping tables respectively corresponding to the multiple sample images, and multiple instructions, where the multiple sample mapping tables indicate a correspondence relationship between pixel values in the multiple sample images generated by the thermographic device in multiple training fields and pixel values in the multiple sample images being optimized; and
a processor, connected to the data capturing circuit and the storage, configured for running a neural network model and accessing the multiple instructions to execute following actions:
action a) updating the neural network model by utilizing the multiple sample images and the multiple sample mapping tables;
action b) inputting the raw image into the neural network model to generate an optimization mapping table; and
action c) converting the raw image into an optimized image by utilizing the optimization mapping table.

Compared to the previous techniques, the disclosure trains the neural network model by utilizing a large quantity of the pre-stored sample images and the sample mapping tables corresponding to specific parameters, and converts a new image into a new mapping table by utilizing the trained neural network model, so as to optimize all pixels of the new image in a lookup table manner. In this way, the disclosure avoids the complex process for the manual parameter adjustment and the parameter re-adjustment being time-consuming for the various environmental fields.

### BRIEF DESCRIPTION OF THE DRAWINGS

FIG. 1 illustrates a block diagram of a thermographic image optimization device 100 in some embodiments of the disclosure.

FIG. 2 illustrates a schematic diagram of a sample mapping table and a sample image in some embodiments of the disclosure.

FIG. 3 illustrates a flowchart of a thermographic image optimization method in some embodiments of the disclosure.

FIG. 4 illustrates a schematic diagram of an optimized image in some embodiments of the disclosure.

### DETAILED DESCRIPTION

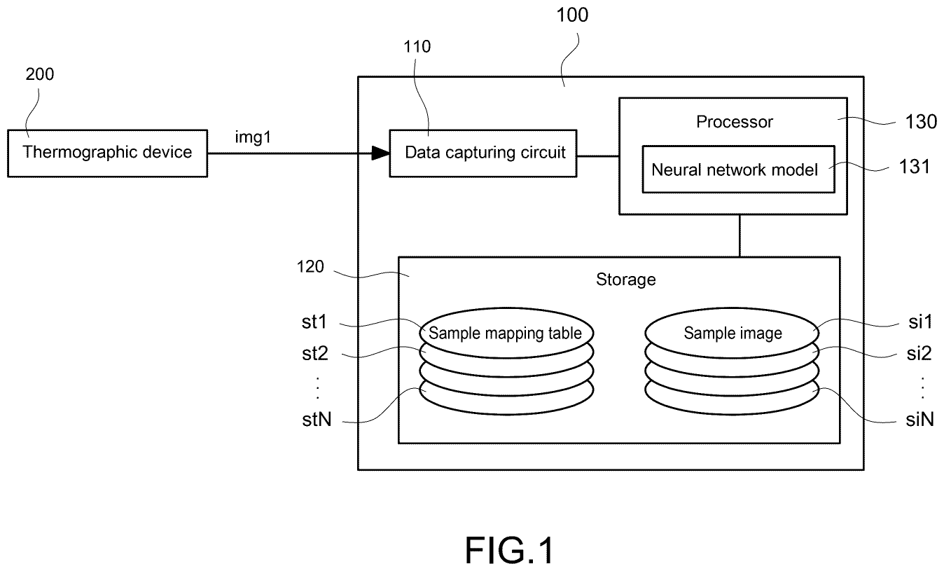

Reference is made to FIG. 1, and FIG. 1 illustrates a block diagram of a thermographic image optimization device 100 in some embodiments of the disclosure. As shown in FIG. 1, in this embodiment, the thermographic image optimization device 100 includes a data capturing circuit 110, a storage 120, and a processor 130. The processor 130 is coupled to the data capturing circuit 110 and the storage 120.

In some embodiments, the thermographic image optimization device 100 is implemented by any data processing device (e.g., a desktop computer, a laptop, or a tablet computer) or any server (e.g., a cloud server, a virtual server, or a rack server). In this embodiment, the data capturing circuit 110 is used for capturing a raw image img1 from a thermographic device 200 in a detection field. In other words, a user can use the thermographic device 200 to capture the detection field to generate the raw image img1 of the detection field. Next, the thermographic image optimization device 100 can be connected to the thermographic device 200 through the data capturing circuit 110 to capture the raw image img1 from the thermographic device 200.

In some embodiments, the detection field is a field (e.g., a street, a factory, or a station) photographed by the thermographic device 200 to generate the raw image img1. In some embodiments, the thermographic device 200 is implemented by any thermographic camera (e.g., a general infrared camera, a quantum instrument, or an optical and infrared composite camera). In some embodiments, the raw image img1 is any type of image (e.g., a grayscale image or a RGB image) generated by the thermographic device 200 that has not been optimized. In some embodiments, the data capturing circuit 110 is any wireless communication circuit (e.g., a Wi-Fi communication circuit or a Bluetooth communication circuit) or any wired communication circuit (e.g., an Ethernet communication circuit) for communication.

In this embodiment, the storage 120 is used for storing multiple sample images si1-siN, multiple sample mapping tables st1-stN corresponding to the sample images si1-siN, and multiple instructions, where N is any positive integer without particular limitation. In some embodiments, the sample images si1-siN are multiple images being not optimized (i.e., all pixel values in the images are unprocessed thermal data) photographed by the thermographic device 200 in multiple training fields, and the sample images si1-siN and the raw image img1 are same type of images (e.g., both grayscale images), where the training fields is a field which is the same as or different from the detection field. In some embodiments, the instructions are implemented by any firmware or any software, and the processor 130 accesses these instructions to execute a thermographic image optimization method described in following paragraphs. In some embodiments, the storage 120 is implemented by a flash memory, a read-only memory, a hard disk, or any other equivalent storage component.

In this embodiment, the sample mapping tables st1-stN indicate a correspondence relationship between pixel values in the sample images si1-siN photographed by the thermographic device 200 in the multiple training fields and pixel values in the sample images si1-siN being optimized. In some embodiments, the sample mapping tables st1-stN are multiple mapping tables generated respectively based on the sample images si1-siN by utilizing any image optimization algorithm (e.g., a histogram equalization algorithm) for optimizing contrast and brightness of the sample images si1-siN. Specifically, the user can pre-set parameters for best contrast, best brightness, and so on for the sample images si1-siN photographed in the multiple training fields, and the sample images si1-siN can be respectively converted (i.e., with a one-to-one correspondence) into the sample mapping tables st1-stN by a specific image optimization algorithm.

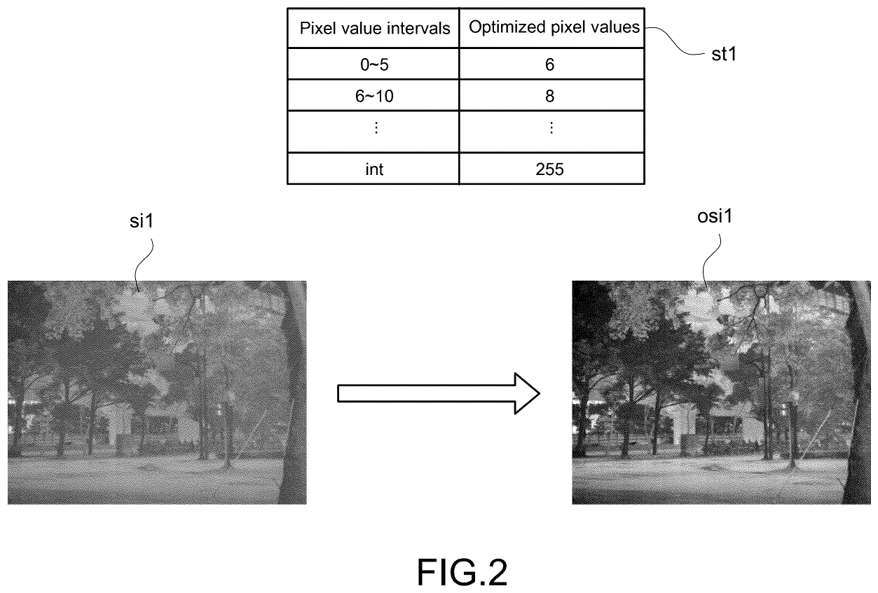

The sample mapping table st1 and the sample image si1 are explained by a practical example below. Reference is made to FIG. 2, and FIG. 2 illustrates a schematic diagram of the sample mapping table st1 and the sample image si1 in some embodiment of the disclosure. As shown in FIG. 2, the sample image si1 is pre-converted into the sample mapping table st1 by the histogram equalization algorithm (e.g., pixel values of all pixels in the sample image si1 are performed statistically analyzing to generate a histogram of multiple pixel value intervals, and then the sample mapping table st1 is generated from the histogram being equalized). The sample mapping table st1 includes the multiple pixel value intervals for all pixels in the sample image si1 and optimized pixel values corresponding to each pixel value interval. Degree of histogram equalization is adjusted by the user by utilizing an optimal alpha parameter being pre-set for the multiple training fields. In this way, the pixel values of all pixels in the sample image si1 are converted into the optimized pixel values respectively corresponding to the pixel values by the sample mapping table st1.

In detail, from the sample mapping table st1, it can be known that when the pixel value of one of the pixel coordinates (e.g., (10, 20)) of the sample image si1 belongs to the pixel value interval of 0-5, the optimized pixel value corresponding to this pixel value is 6. Thereby, the pixel value of the same coordinate (e.g., (10, 20)) of an optimized sample image osi1 is set as 6. Similarly, when the pixel value of another one of the pixel coordinates (e.g., (50, 10)) of the sample image si1 belongs to the pixel value interval of 6-10, the optimized pixel value corresponding to this pixel value is 8. Thereby, the pixel of the same coordinate (e.g., (50, 10)) of the optimized sample image osi1 is set as 8. By analogy, the pixel values of all pixels in the sample image si1 are respectively converted into the optimized pixel values of all pixels in the optimized sample image osi1 by the sample mapping table st1 in a lookup table manner. The other sample mapping tables st2-stN also include similar data as the sample mapping table st1, and are used for converting the respective pixel values of all pixels in the sample images si2-siN into the pixel values of all pixels in the optimized sample images respectively corresponding to the sample images si2-siN. It should be noted that a maximum pixel value interval int in the sample mapping table st1 is determined by data size of the respective sample images si1-siN (e.g., if the data size is 256 bits, the maximum pixel value interval int can be set as the pixel value interval of 250-255; if the data size is 16384 bits, the maximum pixel value interval int can be set as the pixel value interval of 16380-16383).

Returning to FIG. 1, in this embodiment, the processor 130 further executes a neural network model 131. In some embodiments, the neural network model 131 is implemented by any neural network model (e.g., a convolutional neural network model, a deep neural network model, a YOLO model, or a transformer model) for image processing. In some embodiments, the processor 130 is implemented by a central processing unit (CPU), a microcontroller unit (MCU), a programmable logic controller (PLC), a system on chip (SoC), or a field-programmable gate array (FPGA).

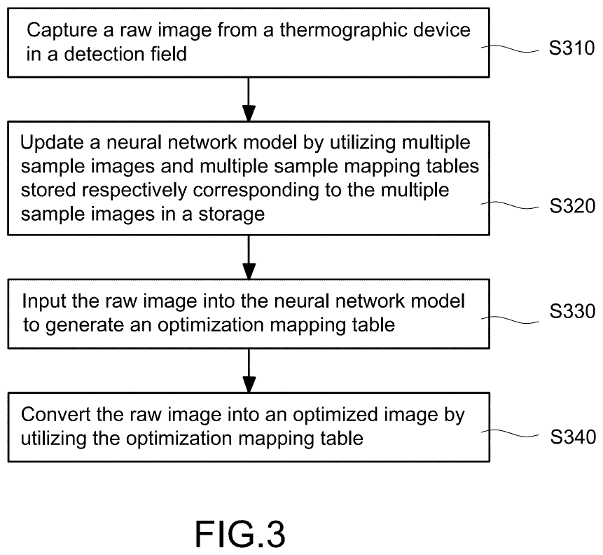

Reference is made to FIG. 3, and FIG. 3 illustrates a flowchart of a thermographic image optimization method in some embodiments of the disclosure. This thermographic image optimization method is applicable to the thermographic image optimization device 100 shown in FIG. 1. As shown in FIG. 3, the thermographic image optimization method includes steps S310-S340.

First, in step S310, the data capturing circuit 110 captures the raw image img1 from the thermographic device 200 in the detection field. In step S320, the processor 130 updates the neural network model 131 by utilizing the sample images si1-siN and the sample mapping tables st1-stN stored in the storage 120.

In some embodiments, the processor 130 utilizes each sample image as training samples, and utilizes the sample mapping table corresponding to each sample image as a training label. Next, the processor 130 inputs each training sample into the neural network model 131 to correspondingly generate a result mapping table as a result label, and calculates a loss between the corresponding result label and the corresponding training label. Next, the processor 130 performs backpropagation on the neural network model 131 based on the calculated loss to update parameters (i.e., respective weights of multiple neural network layers in the neural network model 131) of the neural network model 131. In this way, the processor 130 completes updating the neural network model 131 (i.e., completes a training phase).

In some embodiments, the processor 130 first performs any type of normalization (e.g., min-max normalization or Z-score normalization) on the sample images si1-siN to generate the sample images si1-siN being normalized, and then utilizes each sample image being normalized as the training sample.

In step S330, the processor 130 inputs the raw image img1 into the neural network model 131 to generate an optimization mapping table. In other words, whenever the thermographic device 200 photographs the detection field to generate the raw image img1, the processor 130 inputs this raw image img1 into the neural network model 131 to convert the raw image img1 into the optimization mapping table (i.e., an inference phase). In some embodiments, the optimization mapping table indicates a correspondence relationship between the pixel values of the raw image img1 and the optimized pixel values. Specifically, when the pixel value of one pixel in the raw image img1 belongs to a certain pixel value interval, the optimization mapping table indicates the optimized pixel value corresponding to this pixel value interval. In some embodiments, the processor 130 also first performs any type of normalization (e.g., min-max normalization or Z-score normalization) on the raw image img1 to generate the raw image img1 being normalized, and then input the raw image img1 being normalized into the neural network model 131.

It should be noted that the trained neural network model 131 can automatically adjust various parameters (i.e., the brightness and the contrast) corresponding to the raw image img1 for any detection field to generate the optimization mapping table. Therefore, this method avoids manually adjusting various parameters to generate the optimization mapping table corresponding to the raw image img1.

In step S340, the processor 130 converts the raw image img1 into the optimized image by utilizing the optimization mapping table. In some embodiments, the processor 130 converts the pixel values of multiple pixel coordinates of the raw image img1 into the optimized pixel values by the optimization mapping table in the lookup table manner, thereby converting the raw image img1 into the optimized image. In some embodiments, the processor 130 identifies the pixel value of each pixel coordinate of the raw image img1 respectively belongs to which pixel value interval from the optimization mapping table, and obtains the optimized pixel value corresponding to the pixel value interval which the pixel value belongs to from the optimization mapping table. Next, the processor 130 sets the pixel value of each pixel coordinate of the raw image img1 as the corresponding optimized pixel values, thereby converting the raw image img1 into the optimized image. In some embodiments, the optimization mapping table indicates a correspondence relationship between the multiple pixel value intervals in the raw image and the optimized pixel values.

Specifically, when the pixel value of one pixel in the raw image img1 belongs to a certain pixel value interval, the processor 130 looks up the optimization mapping table to obtain the optimized pixel value corresponding to this pixel value interval, and converts the pixel value of this pixel in the raw image img1 into the corresponding optimized pixel value. By analogy, the processor 130 converts the pixel values of other pixels in the raw image img1 in the same manner. In this way, the processor 130 converts the raw image img1 into the optimized image. In some embodiments, the optimized image belongs to the same type as the raw image img1 (e.g., both the optimized image and the raw image img1 are grayscale images).

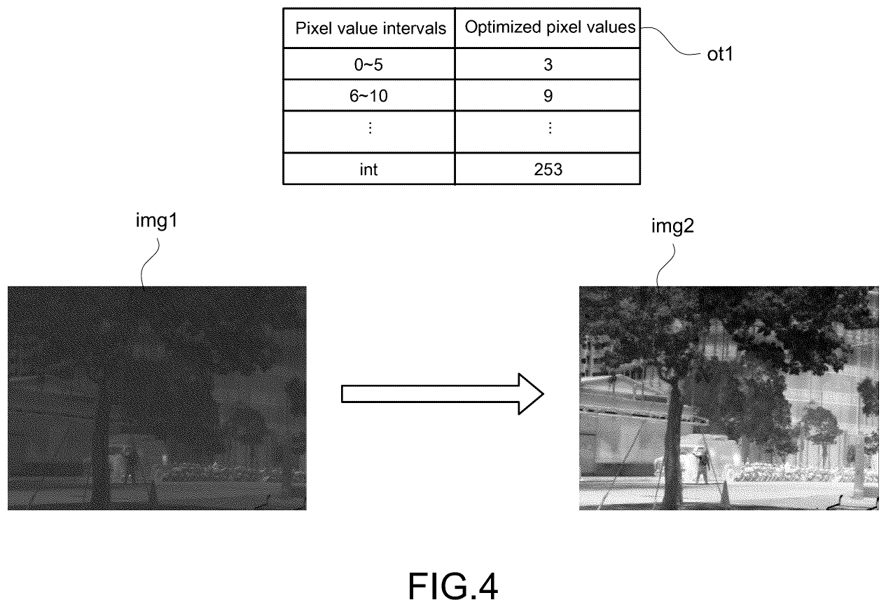

Generating the optimized image is explained by a practical example below. Reference is made to FIG. 4, and FIG. 4 illustrates a schematic diagram of the optimized image img2 in some embodiments of the disclosure. As shown in FIG. 4, the processor 130 inputs the raw image img1 into the neural network model 131 to generate the optimization mapping table ot1. The optimization mapping table ot1 includes the multiple pixel value intervals of all pixels in the raw image img1 and the optimized pixel values corresponding to each pixel value interval.

Next, by querying the optimization mapping table ot1, the processor 130 identifies each pixel in the raw image img1 belongs to which pixel value interval in the optimization mapping table ot1. Next, the processor 130 converts the pixel values of the pixels in the raw image img1 belonging to the pixel value interval of 0-5 into 3, and converts the pixel values of the pixels in the raw image img1 belonging to the pixel value interval of 6-10 into 9. By analogy, the processor 130 converts the pixel values of all pixels in the raw image img1 into the optimized pixel values respectively corresponding to the pixel values in the lookup table manner.

In other words, when the pixel value of one of the pixel coordinate (e.g., (11, 21)) of the raw image img1 belongs to the pixel value interval of 0-5, the processor 130 identifies the optimized pixel value corresponding to this pixel value as 3 by the optimization mapping table ot1 in the lookup table manner. Thereby, the processor 130 sets the pixel value of the same pixel coordinate (e.g., (11, 21)) in the optimized image img2 as 3. When the pixel value of another one of the pixel coordinates (e.g., (55, 15)) of the raw image img1 belongs to the pixel value interval of 6-10, the processor 130 identifies the optimized pixel value corresponding to this pixel value as 9 by the optimization mapping table ot1 in the lookup table manner. Thereby, the processor 130 sets the pixel value of the same pixel coordinate (e.g., (55, 15)) of the optimized image img2 as 9.

By analogy, the processor 130 respectively converts the pixel values of all pixels in the raw image img1 into the pixel values of all pixels in the optimized image img2 by the optimization mapping table ot1 in the lookup table manner. As a result, whenever the thermographic device 200 photographs a new detection field to generate a new raw image, the processor 130 converts the new raw image into a new optimization mapping table, and quickly converts the new raw image into a new optimized image by the new optimization mapping table in the lookup table manner, without the process of previous technologies that utilizes manual parameter adjustment for diversity of different target objects, different detection purposes, different personal subjective perceptions, and different photographed fields. In addition, the method of optimizing the pixels by utilizing the generated optimization mapping table also achieves optimization effect similar to the sample mapping tables st1-stN (i.e., similar optimization for the contrast and the brightness). It should be noted that a maximum pixel value interval int in the optimization mapping table ot1 is determined by data size of the raw image img1 (e.g., if the data size is 256 bits, the maximum pixel value interval int can be set as the pixel value interval of 250-255; if the data size is 16384 bits, the maximum pixel value interval int can be set as the pixel value interval of 16380-16383).

In some embodiments, the thermographic image optimization device 100 further includes a display (not shown). The processor 130 controls the display to show the optimized image img2 for the user to view the optimized image img2 being optimized by the neural network model 131. It should be noted that the displayed optimized image img2 has best contrast, best brightness, and so on. In addition, optimization characteristics of the optimization mapping table ot1 generated by the neural network model 131 is similar to optimization characteristics of the sample mapping tables st1-stN (i.e., similar adjustment can be made to the parameters such as the contrast, the brightness, and other).

In summary, the thermographic image optimization method and device in the disclosure trains the neural network model by utilizing the large number of the pre-stored sample images and the sample mapping tables corresponding to specific parameters. In this way, whenever the thermographic device photographs the new image, the thermographic image optimization method and device in the disclosure converts the new image into the new mapping table by utilizing the trained neural network model, and then optimizes all pixels of the new image (i.e., obtaining the best contrast and the best brightness) in the lookup table manner. As a result, this avoids the manual parameter adjustment and parameter re-adjustment being time-consuming for different environments. In addition, no complex image optimization algorithm is required to optimize the image and maintain best optimization effect.

While this disclosure has been described by means of specific embodiments, numerous modifications and variations may be made thereto by those skilled in the art without departing from the scope and spirit of this disclosure set forth in the claims.

What is claimed is:

1. A thermographic image optimization method, comprising:
step a) by a data capturing circuit, capturing a raw image from a thermographic device in a detection field;
step b) by a processor, updating a neural network model by utilizing a plurality of sample images and a plurality of sample mapping tables respectively corresponding to the plurality of sample images stored in a storage, wherein the plurality of sample mapping tables indicate a correspondence relationship between pixel values in the plurality of sample images generated by the thermographic device in a plurality of training fields and pixel values in the plurality of sample images being optimized;
step c) by the processor, inputting the raw image into the neural network model to generate an optimization mapping table; and
step d) by the processor, converting the raw image into an optimized image by utilizing the optimization mapping table.

2. The thermographic image optimization method of claim 1, wherein the optimization mapping table indicates a correspondence relationship between a plurality of pixel value intervals of the raw image and a plurality of optimized pixel values, wherein each of the sample mapping tables includes a plurality of pixel value intervals of the sample image corresponding to each of the sample mapping tables and a plurality of optimized pixel values respectively corresponding to the plurality of pixel value intervals.

3. The thermographic image optimization method of claim 1, wherein the step b) includes:
by the processor, utilizing the plurality of sample images as a plurality of training samples;
by the processor, utilizing the plurality of sample mapping tables respectively corresponding to the plurality of sample images as a plurality of training labels respectively corresponding to the plurality of training samples; and
by the processor, updating the neural network model by utilizing the plurality of training samples and the plurality of training labels respectively corresponding to the plurality of training samples.

4. The thermographic image optimization method of claim 1, wherein the step d) includes:
by the processor, respectively converting pixel values of a plurality of pixel coordinates of the raw image into pixel values of the pixel coordinates of the optimized image by utilizing the optimization mapping table in a lookup table manner.

5. The thermographic image optimization method of claim 4, wherein the optimization mapping table includes a plurality of pixel value intervals of the raw image and a plurality of optimized pixel values respectively corresponding to the pixel value intervals, wherein the step d) includes:
by the processor, identifying the pixel value of each of the pixel coordinates of the raw image respectively belongs to which pixel value interval from the optimization mapping table, and obtaining the optimized pixel value corresponding to each of the pixel value intervals from the optimization mapping table; and
by the processor, respectively setting the pixel values of each of the pixel coordinates in the optimized image as the optimized pixel values corresponding to each of the pixel value intervals.

6. A thermographic image optimization device, comprising:
a data capturing circuit, configured for capturing a raw image from a thermographic device in a detection field;
a storage, configured for storing a plurality of sample images, a plurality of sample mapping tables respectively corresponding to the plurality of sample images, and a plurality of instructions, wherein the plurality of sample mapping tables indicates a correspondence relationship between pixel values in the plurality of sample images generated by the thermographic device in a plurality of training fields and pixel values in the plurality of sample images being optimized; and
a processor, connected to the data capturing circuit and the storage, configured for running a neural network model and accessing the plurality of instructions to execute following actions:
action a) updating the neural network model by utilizing the plurality of sample images and the plurality of sample mapping tables;
action b) inputting the raw image into the neural network model to generate an optimization mapping table; and
action c) converting the raw image into an optimized image by utilizing the optimization mapping table.

7. The thermographic image optimization device of claim 6, wherein the optimization mapping table indicates a correspondence relationship between a plurality of pixel value intervals of the raw image and a plurality of optimized pixel values, wherein each of the sample mapping tables includes a plurality of pixel value intervals of the sample image corresponding to each of the sample mapping tables and a plurality of optimized pixel values respectively corresponding to the plurality of pixel value intervals.

8. The thermographic image optimization device of claim 6, wherein in action a), the processor is configured for executing following actions:
utilizing the plurality of sample images as a plurality of training samples;
utilizing the plurality of sample mapping tables respectively corresponding to the plurality of sample images as a plurality of training labels respectively corresponding to the plurality of training samples; and
updating the neural network model by utilizing the plurality of training samples and the plurality of training labels respectively corresponding to the plurality of training samples.

9. The thermographic image optimization device of claim 6, wherein in action c), the processor is configured for executing following actions:
respectively converting pixel values of a plurality of pixel coordinates of the raw image into pixel values of the pixel coordinates of the optimized image by utilizing the optimization mapping table in a lookup table manner.

10. The thermographic image optimization device of claim 9, wherein the optimization mapping table includes a plurality of pixel value intervals of the raw image and a plurality of optimized pixel values respectively corresponding to the pixel value intervals, wherein in action c), the processor is configured for executing following actions:
identifying the pixel value of each of the pixel coordinates of the raw image respectively belongs to which pixel value interval from the optimization mapping table, and obtaining the optimized pixel value corresponding to each of the pixel value intervals from the optimization mapping table; and
respectively setting the pixel values of each of the pixel coordinates in the optimized image as the optimized pixel values corresponding to each of the pixel value intervals.
